(19) United States
(12) Patent Application Publication
(10) Pub. No.: US 2018/0338249 A1
(43) Pub. Date: Nov. 22, 2018

(54) COVERAGE HOLE DETECTION APPARATUS AND METHOD

(71) Applicant: Allied Telesis Holdings K.K., Tokyo (JP)

(72) Inventor: Jaehyuk Ryu, Tokyo (JP)

(21) Appl. No.: 15/977,823

(22) Filed: May 11, 2018

(30) Foreign Application Priority Data
May 16, 2017 (JP) 2017-97469

(51) Int. Cl. H04W 16/20; H04W 24/10; H04W 24/02

(52) U.S. Cl. CPC H04W 16/20; H04W 84/18; H04W 24/02; H04W 24/10

(57) ABSTRACT

A coverage hole detection apparatus detects a coverage hole in a wireless LAN including a plurality of wireless LAN access points. The coverage hole detection apparatus includes an intensity measurement instructing unit, a threshold value comparing unit, and a coverage hole existence determining unit. The intensity measurement instructing unit instructs at least one of the wireless LAN access points to measure an intensity of radio waves transmitted from at least one of the other wireless LAN access points. The threshold value comparing unit compares the measured intensity with a predetermined threshold value. The coverage hole existence determining unit determines that the coverage hole exists on a line segment connecting a weak transmission wireless LAN access point that transmits a weak radio wave having the intensity equal to or lower than the predetermined threshold value and a weak reception wireless LAN access point that receives the weak radio wave.

### CROSS REFERENCE TO RELATED APPLICATION

The present application claims priority under 35 U.S.C. § 119 to Japanese Application No. 2017-97469 filed May 16, 2017, the entire content of which is incorporated herein by reference.

### FIELD OF THE INVENTION

The present invention relates to detection of coverage holes in a wireless LAN (Local Area Network).

### BACKGROUND OF THE INVENTION

Conventionally, a wireless LAN having a plurality of wireless LAN (Local Area Network) access points has been known. In such a wireless LAN, the term “coverage hole” refers to a region where radio waves from the wireless LAN access points do not reach, making communication through the wireless LAN unavailable. Hence, the coverage hole is known to be detected by measuring radio waves using a wireless LAN station or a radio wave measuring apparatus (for example, see Japanese Unexamined Patent Application Publication No. 2017-038299).

However, in order to measure radio waves by a radio wave measuring apparatus or the like, there occurs a need for steps of bringing the radio wave measuring apparatus or the like into a region where a coverage hole is assumed to exist. In addition, as the state of radio waves may vary with time, a measurement by the radio wave measuring apparatus or the like needs to be performed a plurality of times while changing the time, which requires even more steps to bring in the radio wave measuring apparatus or the like.

### SUMMARY OF THE INVENTION

Therefore, it is an object of the present invention to reduce the steps required to detect coverage holes in the wireless LAN.

According to the present invention, a coverage hole detection apparatus that detects a coverage hole in a wireless LAN including a plurality of wireless LAN access points, includes: an intensity measurement instructing unit that instructs at least one of the wireless LAN access points to measure an intensity of radio waves transmitted from at least one of the other wireless LAN access points; a threshold value comparing unit that compares the measured intensity with a predetermined threshold value; and a coverage hole existence determining unit that determines that the coverage hole exists on a line segment connecting a weak transmission wireless LAN access point that transmits a weak radio wave having the intensity equal to or lower than the predetermined threshold value and a weak reception wireless LAN access point that receives the weak radio wave.

According to the thus constructed coverage hole detection apparatus, the coverage hole detection apparatus detects a coverage hole in a wireless LAN including a plurality of wireless LAN access points. An intensity measurement instructing unit instructs at least one of the wireless LAN access points to measure an intensity of radio waves transmitted from at least one of the other wireless LAN access points. A threshold value comparing unit compares the measured intensity with a predetermined threshold value. A coverage hole existence determining unit determines that the coverage hole exists on a line segment connecting a weak transmission wireless LAN access point that transmits a weak radio wave having the intensity equal to or lower than the predetermined threshold value and a weak reception wireless LAN access point that receives the weak radio wave.

According to the coverage hole detection apparatus of the present invention, the intensity measurement instructing unit may instruct each of the plurality of wireless LAN access points to measure intensities of radio waves transmitted from the other wireless LAN access points.

According to the coverage hole detection apparatus of the present invention, the wireless LAN may conform to the IEEE802. 11s standard.

According to the coverage hole detection apparatus of the present invention, the intensity measurement may instruct unit may instruct the at least one of the wireless LAN access points to measure the intensity of the radio waves for a plurality of channels.

According to the present invention, a coverage hole detection method of detecting a coverage hole in a wireless LAN including a plurality of wireless LAN access points, includes: an intensity measurement instructing step that instructs at least one of the wireless LAN access points to measure an intensity of radio waves transmitted from at least one of the other wireless LAN access points; a threshold value comparing step that compares the measured intensity with a predetermined threshold value; and a coverage hole existence determining step that determines that the coverage hole exists on a line segment connecting a weak transmission wireless LAN access point that transmits a weak radio wave having the intensity equal to or lower than the predetermined threshold value and a weak reception wireless LAN access point that receives the weak radio wave.

### BRIEF DESCRIPTION OF DRAWINGS

FIG. 1 is a diagram schematically illustrating a positional relation of wireless LAN access points in a wireless LAN 20 according to an embodiment of the present invention;

FIG. 2 is a functional block diagram showing a configuration of the coverage hole detection apparatus 10; and

FIG. 3 is a diagram showing the radio wave intensities measured by the wireless LAN access points 20A, 20B, 20C, and 20D.

### DESCRIPTION OF THE PREFERRED EMBODIMENTS

Hereinafter, a description will be given of an embodiment of the present invention referring to drawings.

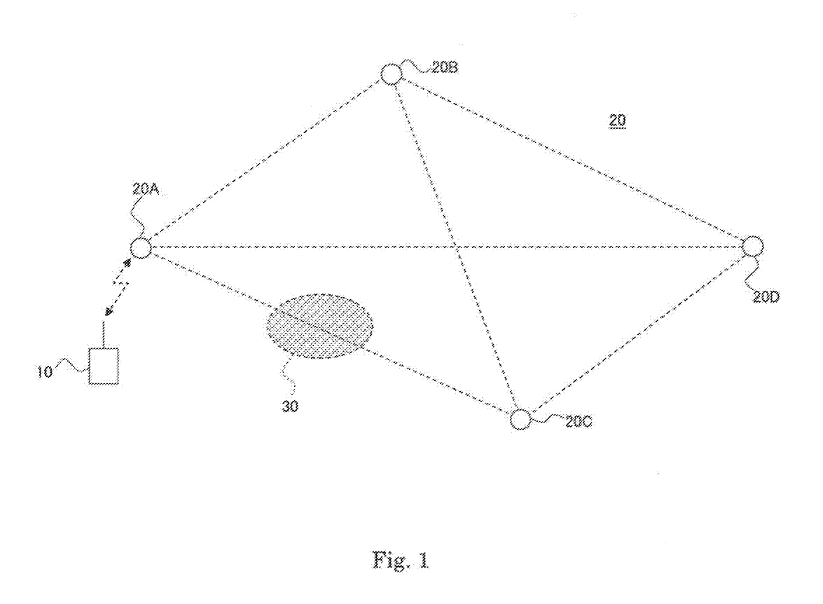

FIG. 1 is a diagram schematically illustrating a positional relation of wireless LAN access points in a wireless LAN 20 according to an embodiment of the present invention.

The wireless LAN 20 according to the embodiment of the present invention includes a plurality of wireless LAN access points 20A, 20B, 20C, and 20D. The wireless LAN 20 conforms to the IEEE802.11s standard. In the wireless LAN 20, a coverage hole 30 exists. The wireless LAN access points 20A, 20B, 20C, and 20D are arranged at positions where they can communicate with each other unless the coverage hole 30 exists.

The coverage hole 30 is a region in which radio waves from the wireless LAN access points 20A, 20B, 20C, and 20D do not reach a wireless communication terminal at a required intensity, making communication by the wireless communication terminal unavailable. The coverage hole 30 according to the embodiment of the present invention is on a line segment connecting the wireless LAN access point 20A and the wireless LAN access point 20C.

The wireless LAN access points 20A, 20B, 20C, and 20D are not one-dimensional points but three-dimensional objects. However, as compared to the distances (e.g., 10 to 20 meters) between the wireless LAN access points 20A, 20B, 20C, and 20D, the sizes (e.g., about 20 centimeters wide) of the wireless LAN access points 20A, 20B, 20C, and 20D are extremely small. Thus, the wireless LAN access points 20A, 20B, 20C, and 20D can be treated as substantially one-dimensional points. Therefore, the line segment connecting the wireless LAN access point 20A and the wireless LAN access point 20C can be uniquely specified.

A coverage hole detection apparatus 10 detects the coverage hole 30. In the embodiment of the present invention, the coverage hole detection apparatus 10 performs wireless communication with the wireless LAN access point 20A. However, the coverage hole detection apparatus 10 may perform wired communication with the wireless LAN access point 20A. Further, the coverage hole detection apparatus 10 may perform wireless communication or wired communication with other wireless LAN access points 20B, 20C, and 20D. The coverage hole detection apparatus 10 may communicate with a wireless LAN controller, which is not shown (which controls the wireless LAN access points 20A, 20B, 20C, and 20D).

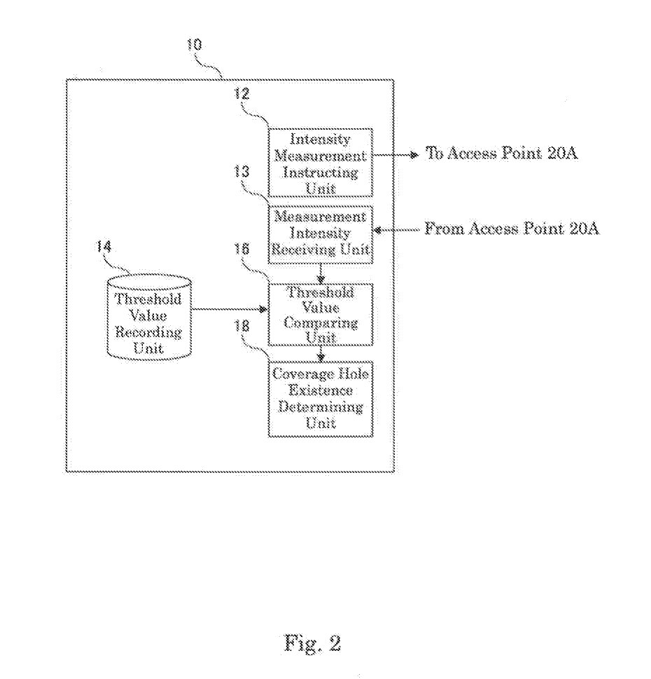

FIG. 2 is a functional block diagram showing a configuration of the coverage hole detection apparatus 10. The coverage hole detection apparatus 10 includes an intensity measurement instructing unit 12, a measurement intensity receiving unit 13, a threshold value recording unit 14, a threshold value comparing unit 16, and a coverage hole existence determining unit 18.

The intensity measurement instructing unit 12 instructs at least one wireless LAN access point (for example, the wireless LAN access point 20A) to measure the intensity of radio waves transmitted from at least one of the other wireless LAN access points (for example, the wireless LAN access point 20C).

It should be noted that the intensity measurement instructing unit 12 may instruct each of a plurality of wireless LAN access points to measure the intensities of radio waves transmitted from the plurality of other wireless LAN access points. Therefore, in the embodiment of the present invention, such an example will be described below.

That is, in the embodiment of the present invention, the intensity measurement instructing unit 12 instructs:

(1) the wireless LAN access point 20A to measure the intensity of radio waves transmitted from the other wireless LAN access points 20B, 20C, and 20D;

(2) the wireless LAN access point 20B to measure the intensity of radio waves transmitted from the other wireless LAN access points 20A, 20C, and 20D;

(3) the wireless LAN access point 20C to measure the intensity of radio waves transmitted from the other wireless LAN access points 20A, 20B, and 20D; and

(4) the wireless LAN access point 20D to measure the intensity of radio waves transmitted from the other wireless LAN access points 20A, 20B, and 20C.

The wireless LAN 20 conforming to the IEEE802.11s standard can simultaneously execute the measurements (1) to (4).

Here, the intensity measurement instructing unit 12 instructs the measurement of the intensity of the radio wave not only for one channel but also for a plurality of channels used in the wireless LAN 20.

The measurement intensity receiving unit 13 receives the measured intensity of the radio waves from the wireless LAN access point 20A. Alternatively, the measurement intensity receiving unit 13 may receive the measured intensity of the radio waves from the wireless LAN access point 20B, 20C, or 20D. In addition, the measurement intensity receiving unit 13 may receive the measured intensity of the radio waves from the wireless LAN access point 20A, 20B, 20C, or 20D via a wireless LAN controller (not shown).

The threshold value recording unit 14 records a predetermined threshold value to be compared with the radio wave intensities measured by the wireless LAN access points 20A, 20B, 20C, and 20D. For example, the predetermined threshold value is (measured intensity of radio wave)/(intensity of radio wave at a transmission source)=20%. The value of 20% means the radio wave intensity that is required at the wireless LAN access point for measurement when the wireless LAN access point for measurement and the wireless LAN access point at the transmission source communicate with each other. The value of 20% may be defined as the specification of the wireless LAN access point.

The threshold value comparing unit 16 receives the radio wave intensities measured by the wireless LAN access points 20A, 20B, 20C, and 20D from the measurement intensity receiving unit 13, and compares each measured intensity with a predetermined threshold value.

The coverage hole existence determining unit 18 determines that the coverage hole 30 exists on a line segment connecting a weak transmission wireless LAN access point that has transmitted weak radio waves having an intensity equal to or lower than the predetermined threshold value and a weak reception wireless LAN access point that has received the weak radio waves.

For example, it is assumed that the wireless LAN access point 20A measures the intensity of the radio waves transmitted from the wireless LAN access point 20C, resulting in a value of (the radio wave intensity measured by the wireless LAN access point 20A)/(the radio wave intensity at the wireless LAN access point 20C)=5% (<20%). In this case, the weak transmission wireless LAN access point is the wireless LAN access point 20C. The weak reception wireless LAN access point is the wireless LAN access point 20A. Thus, the coverage hole existence determining unit 18 determines that the coverage hole 30 exists on the line segment connecting the wireless LAN access point 20C and the wireless LAN access point 20A.

In the coverage hole 30, radio waves strong enough to enable wireless communication by a wireless communication terminal cannot be received. Therefore, in the coverage hole 30, the radio wave transmitted from the wireless LAN access point 20C is also weak. Meanwhile, the sensitivity of an antenna of the wireless LAN access points 20A (and 20B to 20D) is better than that of the wireless communication terminal antenna. Because of this, a radio wave that has passed through the coverage hole 30 from the wireless LAN access point 20C to reach the wireless LAN access point 20A can be detected by the wireless LAN access point 20A even though the radio wave is weak. However, as this radio wave is weak when it reaches the wireless LAN access point 20A, the intensity thereof is equal to or lower than a predetermined threshold value (the communication between the wireless LAN access points 20A and 20C is impossible).

Next, the operation of the embodiment of the present invention will be described.

The intensity measurement instructing unit 12 of the coverage hole detection apparatus 10 instructs the wireless LAN access point 20A to measure the intensities of the radio waves transmitted from the other wireless LAN access points 20B, 20C, and 20D. Each of these radio waves is a radio wave for one channel.

The intensity measurement instructing unit 12 of the coverage hole detection apparatus 10 also instructs, via the wireless LAN access point 20A, each of the wireless LAN access points 20B, 20C, and 20D to measure the intensity of radio waves transmitted from the other wireless LAN access points.

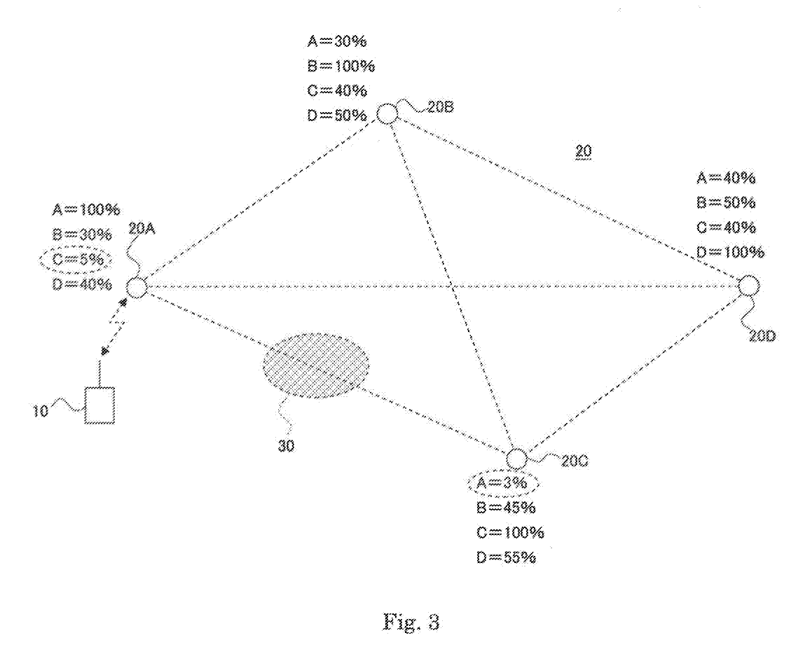

FIG. 3 is a diagram showing the radio wave intensities measured by the wireless LAN access points 20A, 20B, 20C, and 20D. In FIG. 3, measurement results are shown in the vicinity of each of the wireless LAN access points. In FIG. 3, for example, the measurement results of the wireless LAN access point 20A are shown as “B=30%, C=5%, D=40%”. This means that (the radio wave intensity measured by the wireless LAN access point 20A)/(the radio wave intensity at the wireless LAN access point 20B as the transmission source)=30%, (the radio wave intensity measured by the wireless LAN access point 20A)/(the radio wave intensity at the wireless LAN access point 20C as the transmission source)=5%, and (the radio wave intensity measured by the wireless LAN access point 20A)/(the radio wave intensity at the wireless LAN access point 20D as the transmission source)=40%.

Note that “C=5%” in the measurement result of the wireless LAN access point 20A is surrounded by a dash line, which means that the measurement result is equal to or lower than the predetermined threshold value.

In addition, “A=100%” in the vicinity of the wireless LAN access point 20A means that the intensity of the radio wave transmitted by the wireless

LAN access point 20A remains as it is (100%) at the transmission source. The wireless LAN access point 20A does not necessarily need to measure the intensity of the radio wave transmitted from the wireless LAN access point 20A.

The measurement results of the other wireless LAN access points 20B, 20C, and 20D are also illustrated in FIG. 3.

It should be noted that “A=3%” in the measurement result of the wireless LAN access point 20C is surrounded by a dash line, which means that the measurement result is equal to or lower than the predetermined threshold value.

The above-mentioned measurement results of the wireless LAN access points 20A, 20B, 20C, and 20D are received by the measurement intensity receiving unit 13 of the coverage hole detection apparatus 10 via the wireless LAN access point 20A.

The threshold value comparing unit 16 compares the threshold value (20%) recorded in the threshold value recording unit 14 with the measurement result received by the measurement intensity receiving unit 13.

The coverage hole existence determining unit 18 determines that the coverage hole 30 exists on a line segment connecting the weak transmission wireless LAN access point that has transmitted a weak radio wave having an intensity equal to or lower than the predetermined threshold value (20%) and the weak reception wireless LAN access point that has received the weak radio wave.

In the example shown in FIG. 3, because of “C=5%” in the measurement result of the wireless LAN access point 20A, the weak transmission wireless LAN access point is the wireless LAN access point 20C, and the weak reception wireless LAN access point is the wireless LAN access point 20A. Moreover, because of “A=3%” in the measurement result of the wireless LAN access point 20C, the weak transmission wireless LAN access point is the wireless LAN access point 20A, and the weak reception wireless LAN access point is the wireless LAN access point 20C.

Therefore, the coverage hole existence determining unit 18 determines that the coverage hole 30 exists on the line segment connecting the wireless LAN access point 20A and the wireless LAN access point 20C.

As described above, the radio waves for one channel are measured by each of the wireless LAN access points 20A, 20B, 20C, and 20D, thereby detecting the coverage hole 30.

The intensity measurement instructing unit 12 of the coverage hole detection apparatus 10 also instructs the wireless LAN access points to measure the radio waves for the other channels used in the wireless LAN 20, in the same way, thereby detecting the coverage hole 30.

The detected coverage hole 30 can be eliminated by adding a wireless LAN access point in the vicinity thereof. As the number of wireless LAN access points increases in this way, the possibility that the coverage hole 30 exists on a line segment connecting any two wireless LAN access points increases, which leads to the increase in the possibility that the coverage hole 30 can be detected.

According to the embodiment of the present invention, radio waves are measured by the wireless LAN access points 20A to 20D in the wireless LAN 20, the coverage hole 30 is detected based on the measurement results. This can eliminate the steps of bringing in a new radio wave measuring apparatus for detection of the coverage hole 30, into a region where the coverage hole 30 is thought to exist. Therefore, the steps of detecting the coverage hole 30 in the radio LAN 20 can be reduced.

Moreover, from the viewpoint of the possibility that the radio wave condition in the wireless LAN 20 varies with time, even if the radio wave is measured a plurality of times while changing the time, there is no need to bring in a new radio wave measuring apparatus or the like every time. For this reason, the detection of the coverage hole 30 becomes easy by performing measurement of radio waves a plurality of times while changing the time.

The above-mentioned embodiment can be implemented as follows. A computer equipped with a CPU, a hard disk, and a medium (such as a floppy (registered trademark) disk or a CD-ROM) reading device reads a medium that records therein programs for implementing the above-mentioned portions, for example, each portion of the coverage hole detection apparatus 10, and then the read program is installed in the hard disk. Such a method can also achieve the above functions.

What is claimed is:

1. A coverage hole detection apparatus that detects a coverage hole in a wireless LAN including a plurality of wireless LAN access points, the coverage hole detection apparatus comprising:
an intensity measurement instructing unit that instructs at least one of the wireless LAN access points to measure an intensity of radio waves transmitted from at least one of the other wireless LAN access points;
a threshold value comparing unit that compares the measured intensity with a predetermined threshold value; and
a coverage hole existence determining unit that determines that the coverage hole exists on a line segment connecting a weak transmission wireless LAN access point that transmits a weak radio wave having the intensity equal to or lower than the predetermined threshold value and a weak reception wireless LAN access point that receives the weak radio wave.

2. The coverage hole detection apparatus according to claim 1, wherein
the intensity measurement instructing unit instructs each of the plurality of wireless LAN access points to measure intensities of radio waves transmitted from the other wireless LAN access points.

3. The coverage hole detection apparatus according to claim 1, wherein
the wireless LAN conforms to the IEEE802.11s standard.

4. The coverage hole detection apparatus according to claim 1, wherein
the intensity measurement instructing unit instructs the at least one of the wireless LAN access points to measure the intensity of the radio waves for a plurality of channels.

5. A coverage hole detection method of detecting a coverage hole in a wireless LAN including a plurality of wireless LAN access points, the coverage hole detection method comprising:
an intensity measurement instructing step that instructs at least one of the wireless LAN access points to measure an intensity of radio waves transmitted from at least one of the other wireless LAN access points;
a threshold value comparing step that compares the measured intensity with a predetermined threshold value; and
a coverage hole existence determining step that determines that the coverage hole exists on a line segment connecting a weak transmission wireless LAN access point that transmits a weak radio wave having the intensity equal to or lower than the predetermined threshold value and a weak reception wireless LAN access point that receives the weak radio wave.
